(19) United States
(12) Patent Application Publication
(10) Pub. No.: US 2015/0250187 A1
(43) Pub. Date: Sep. 10, 2015

(54) HEATING COOKER

(71) Applicant: SHARP KABUSHIKI KAISHA, Osaka-shi, Osaka (JP)

(72) Inventors: Yasuaki Sakane, Osaka-shi (JP); Norihiro Kuma, Osaka-shi (JP); Akihiro Yoshidome, Osaka-shi (JP)

(73) Assignee: SHARP KABUSHIKI KAISHA, Osaka-shi, Osaka (JP)

(21) Appl. No.: 14/433,920

(22) PCT Filed: Nov. 29, 2013
(86) PCT No.: PCT/JP2013/082217

§ 371 Date: Apr. 7, 2015

(30) Foreign Application Priority Data
Nov. 30, 2012 (JP) 2012-262744

(51) Int. Cl. A21B 1/26; A21B 1/42

(52) U.S. Cl. CPC A21B 1/26; A21B 1/42

(57) ABSTRACT

A housing, a container accommodated in the housing with a central axis being inclined at a prescribed angle with respect to a vertical direction, for accommodating a heated object, a hot air blowing mechanism blowing hot air into the container, and a drive mechanism rotationally moving the container around the central axis are provided.

### TECHNICAL FIELD

The present invention relates to a heating cooker and particularly to a heating cooker heating a heated object by blowing hot air thereto.

### BACKGROUND ART

International Publication WO2012/032449 (PTD 1) and U.S. Pat. No. 7,993,694 (PTD 2) are prior documents each disclosing a heating cooker heating a heated object by blowing hot air thereto.

The heating cooker described in PTD 1 heats a heated object in a container with hot air circulated by a fan. The heating cooker described in PTD 2 heats a heated object by blowing hot air into a container while the heated object is stirred by a blade arranged in the container.

### CITATION LIST

### Patent Document

PTD 1: International Publication WO2012/032449

PTD 2: U.S. Pat. No. 7,993,694

### SUMMARY OF INVENTION

### Technical Problem

In heating a heated object by blowing hot air thereto, it is difficult to heat the heated object by uniformly blowing hot air to the entire heated object. Circulation of hot air alone cannot achieve uniform blowing of hot air to the entire heated object in the container. When a heated object is stirred by a blade, there are some unfavorable cases that a heated object deforms depending on characteristics of the heated object.

The present invention was made in view of the problems above, and an object thereof is to provide a heating cooker capable of uniformly heating a heated object in accordance with characteristics of the heated object.

### Solution to Problem

A heating cooker based on the present invention includes a housing, a container accommodated in the housing with a central axis being inclined at a prescribed angle with respect to a vertical direction, for accommodating a heated object, a hot air blowing mechanism blowing hot air into the container, and a drive mechanism rotationally moving the container around the central axis.

In one form of the present invention, the housing has a door. The container has an opening at a position opposed to the door. The hot air blowing mechanism blows hot air into the container through the opening.

In one form of the present invention, the drive mechanism can rotationally move the container with at least one of a direction of rotation, a rotation speed, and an angle of rotation being varied.

In one form of the present invention, the hot air blowing mechanism can vary a temperature of blown hot air.

In one form of the present invention, the heating cooker further includes in the housing, a heating mechanism heating the container in proximity to at least a part of a peripheral side portion and a bottom portion of the container.

In one form of the present invention, the heating cooker further includes an angle adjustment mechanism coupled to the housing, which is capable of adjusting an angle of inclination of the housing so as to vary the prescribed angle.

### Advantageous Effects of Invention

According to the present invention, a heated object can uniformly be heated in accordance with characteristics of the heated object.

### BRIEF DESCRIPTION OF DRAWINGS

FIG. 1 is a perspective view showing appearance of a heating cooker according to a first embodiment of the present invention.

FIG. 2 is a front view showing appearance of the heating cooker according to the first embodiment.

FIG. 3 is a top view of the heating cooker in FIG. 2 viewed in a direction shown with an arrow III.

FIG. 4 is a side view of the heating cooker in FIG. 2 viewed in a direction shown with an arrow IV.

FIG. 5 is a perspective view showing a state that a door of the heating cooker according to the first embodiment is opened.

FIG. 6 is a cross-sectional view of the heating cooker in FIG. 2 viewed in a direction shown with an arrow VI-VI.

FIG. 7 is a cross-sectional view schematically showing a structure of the heating cooker according to the first embodiment.

FIG. 8 is a front view schematically showing a structure of the heating cooker according to the first embodiment.

FIG. 9 is a diagram showing a state of the heating cooker according to the first embodiment that a heated object is heated while a container is swung.

FIG. 10 is a diagram showing a state of the heating cooker according to the first embodiment that a heated object is heated while the container is rotated in one direction.

FIG. 11 is a graph showing results in a verification example.

FIG. 12 is a diagram defining a direction of rotation of a container.

FIG. 13 is a diagram showing a first operation example of a container owing to a drive mechanism.

FIG. 14 is a diagram showing a second operation example of the container owing to the drive mechanism.

FIG. 15 is a diagram showing a third operation example of the container owing to the drive mechanism.

FIG. 16 is a diagram showing a state that four heated objects are evenly placed on a support member arranged in the container.

FIG. 17 is a diagram showing a state that three heated objects are evenly placed on the support member.

FIG. 18 is a diagram showing a state that a plurality of heated objects which tend to stick with one another are evenly arranged on the support member.

FIG. 19 is a vertical cross-sectional view showing a structure of a heating cooker according to a second embodiment of the present invention.

FIG. 20 is a lateral cross-sectional view showing a structure of the heating cooker according to the second embodiment.

FIG. 21 is a lateral cross-sectional view showing a state of the heating cooker according to the second embodiment that a container has been removed by opening a door.

FIG. 22 is a vertical cross-sectional view across a main body portion of a housing in the heating cooker according to the second embodiment.

FIG. 23 is a vertical cross-sectional view across the door in the heating cooker according to the second embodiment.

FIG. 24 is a perspective view showing appearance of a heating cooker according to a third embodiment of the present invention.

FIG. 25 is a see-through view showing a structure of an angle adjustment mechanism of the heating cooker according to the third embodiment.

FIG. 26 is a vertical cross-sectional view showing a structure of a heating cooker according to a fourth embodiment of the present invention.

FIG. 27 is a lateral cross-sectional view showing a state of the heating cooker according to the fourth embodiment that a container has been removed by opening a door.

FIG. 28 is a vertical cross-sectional view across a main body portion of a housing in the heating cooker according to the fourth embodiment.

FIG. 29 is a vertical cross-sectional view across the door of the heating cooker according to the fourth embodiment.

FIG. 30 is a vertical cross-sectional view showing a state that an angle of inclination of a container is set to 5°.

FIG. 31 is a vertical cross-sectional view showing a state that a door is opened with an angle of inclination of a container being set to 95°.

### DESCRIPTION OF EMBODIMENTS

A heating cooker according to a first embodiment of the present invention will be described hereinafter with reference to the drawings. In the description of embodiments below, the same or corresponding elements in the drawings have the same reference characters allotted and description thereof will not be repeated.

### First Embodiment

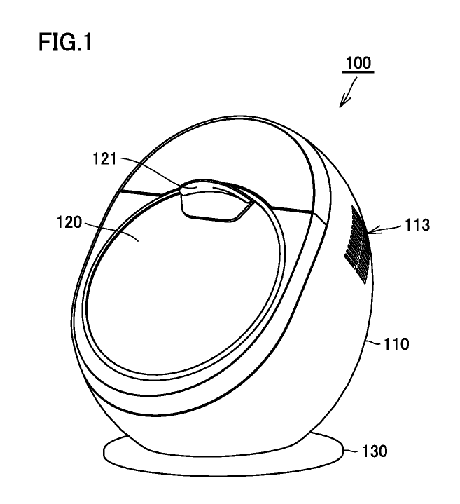

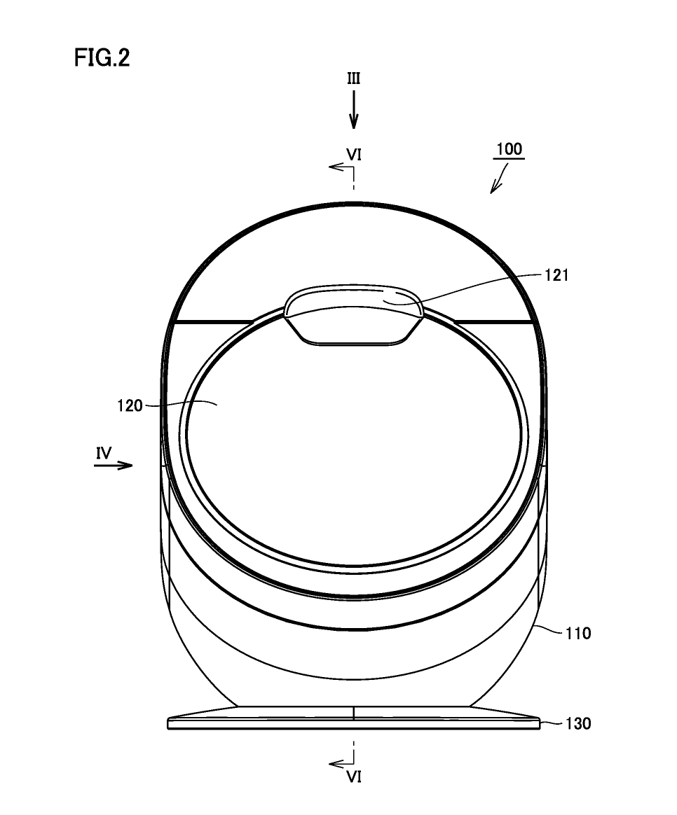

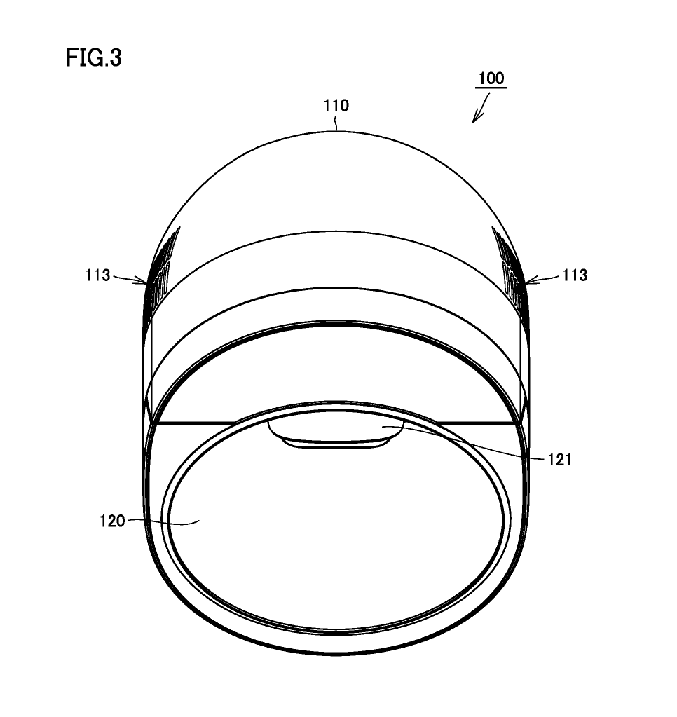

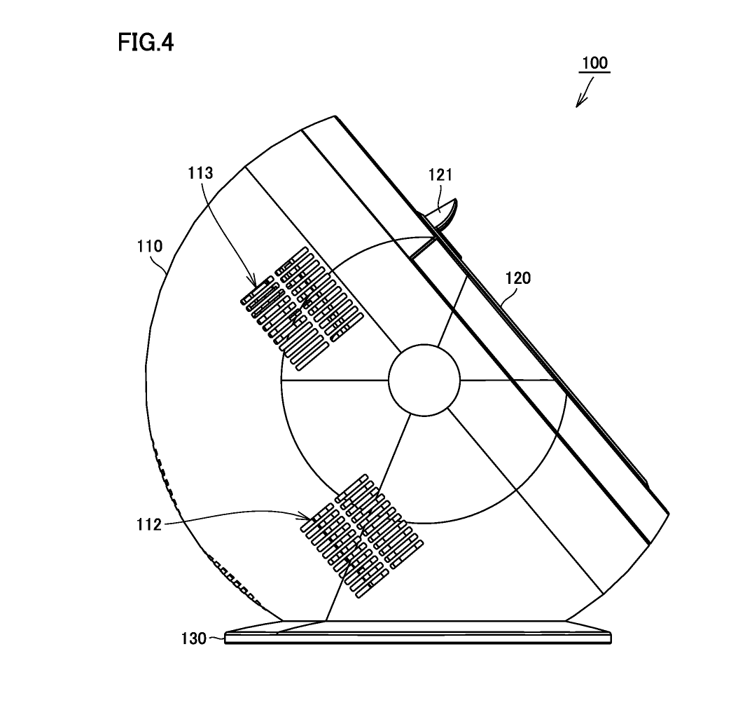

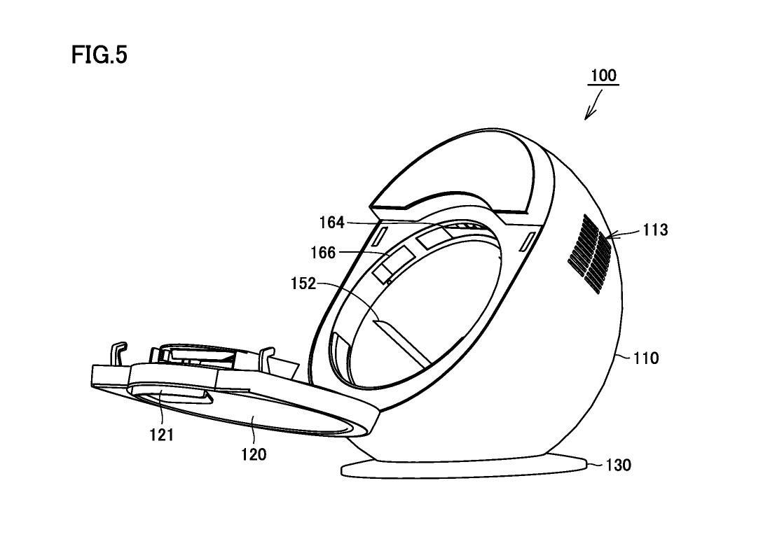

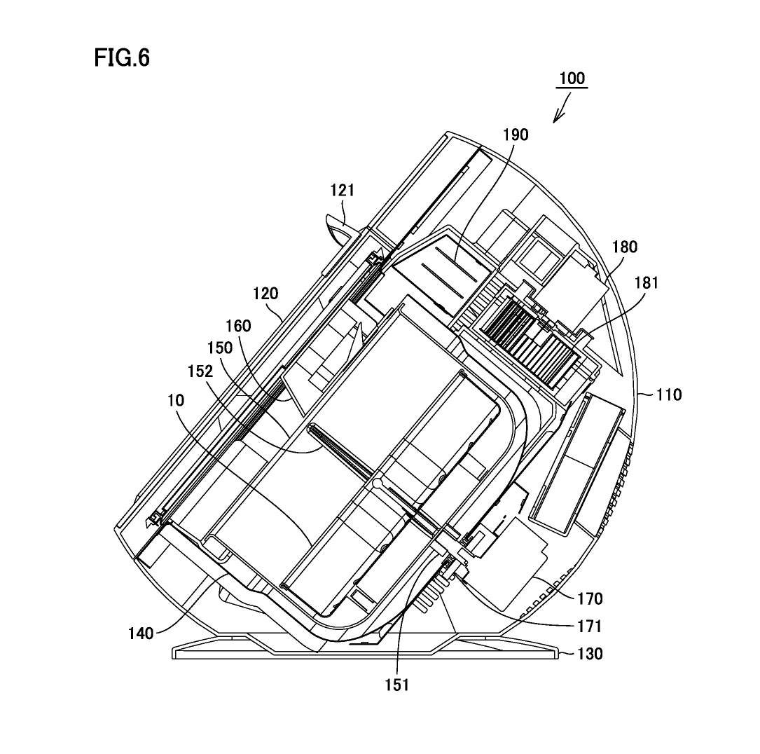

FIG. 1 is a perspective view showing appearance of a heating cooker according to the first embodiment of the present invention. FIG. 2 is a front view showing appearance of the heating cooker according to the present embodiment. FIG. 3 is a top view of the heating cooker in FIG. 2 viewed in a direction shown with an arrow III. FIG. 4 is a side view of the heating cooker in FIG. 2 viewed in a direction shown with an arrow IV. FIG. 5 is a perspective view showing a state that a door of the heating cooker according to the present embodiment is opened. FIG. 6 is a cross-sectional view of the heating cooker in FIG. 2 viewed in a direction shown with an arrow VI-VI.

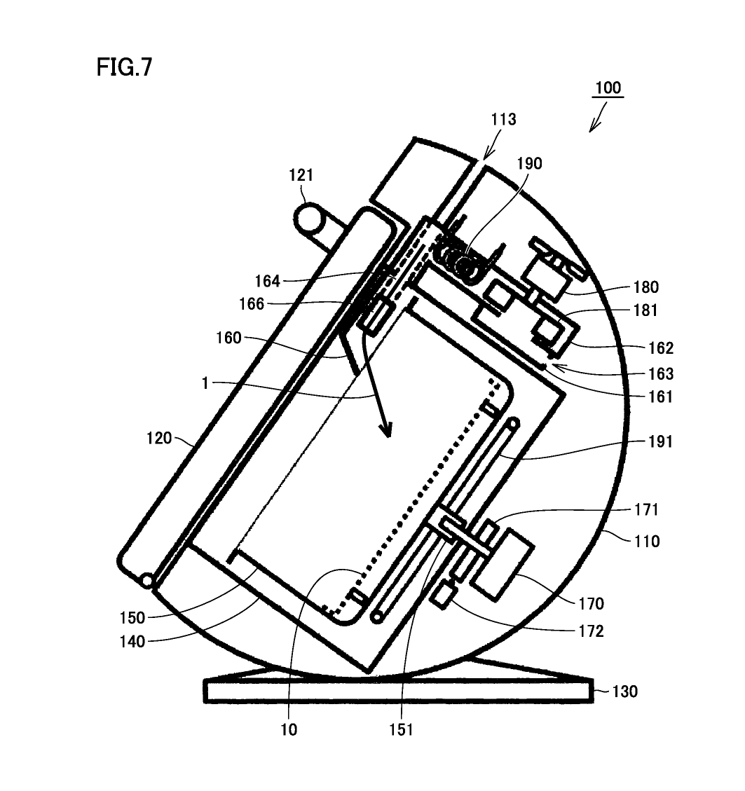

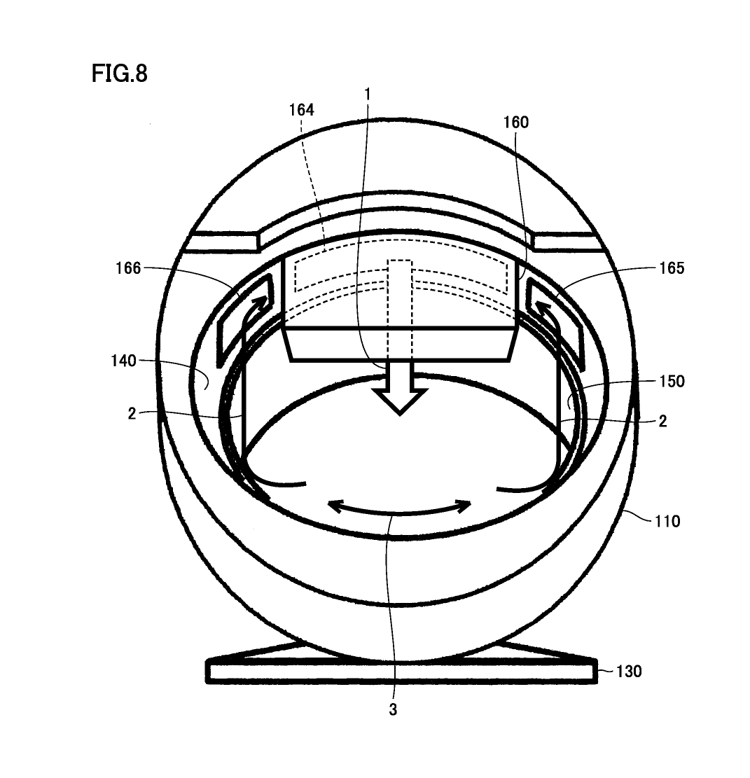

FIG. 7 is a cross-sectional view schematically showing a structure of the heating cooker according to the present embodiment. FIG. 8 is a front view schematically showing a structure of the heating cooker according to the present embodiment. FIG. 7 illustrates also a feature not located on the same cross-section for ease of illustration. FIG. 8 shows a state that the door has been removed.

As shown in FIGS. 1 to 8, a heating cooker 100 according to the first embodiment of the present invention includes a housing, a container 150 accommodated in the housing with a central axis being inclined at a prescribed angle with respect to a vertical direction, for accommodating a heated object, a hot air blowing mechanism blowing hot air into container 150, and a drive mechanism rotationally moving container 150 around the central axis.

As shown in FIGS. 1 to 6, the housing includes a substantially hemispherical main body portion 110 and a door 120 coupled to main body portion 110. The housing is fixed onto a base 130. Door 120 is provided obliquely above main body portion 110. A handle 121 is provided at an upper end of door 120.

An outside air intake port 112 including a plurality of holes is formed in a lower portion of a side of main body portion 110 of the housing. An exhaust port 113 including a plurality of holes is formed in an upper portion of the side of main body portion 110 of the housing.

As shown in FIGS. 6 to 8, a heating chamber 140 is provided in main body portion 110 of the housing. Heating chamber 140 has an opening opened and closed by door 120. A space is formed outside heating chamber 140 within main body portion 110 of the housing. This space is in contact with outside air intake port 112.

Container 150 is arranged in heating chamber 140. Container 150 has an opening at an upper end. Container 150 arranged in heating chamber 140 has a central axis inclined at a prescribed angle with respect to a vertical direction. In the present embodiment, the central axis of container 150 is inclined by approximately 45° with respect to the vertical direction. The prescribed angle is not limited thereto, and the angle may be, for example, not smaller than 45° and not greater than 60°.

Specifically, a central axis of heating chamber 140 is inclined at a prescribed angle with respect to the vertical direction. Container 150 is rotationally movably supported by a plurality of not-shown rollers provided between a peripheral wall of container 150 and an inner wall of heating chamber 140. Consequently, the central axis of container 150 is inclined at a prescribed angle with respect to the vertical direction. The opening in container 150 arranged in heating chamber 140 is opposed to door 120 at a prescribed distance therefrom.

As shown in FIGS. 5 and 6, a protruding piece 152 in a flat plate shape which protrudes inward of container 150 is provided on an inner wall of container 150. In the present embodiment, three protruding pieces 152 are provided evenly at an interval of 120° on the inner wall of container 150.

This protruding piece 152 functions as a stirring plate in stirring of a heated object and an attachment plate in attachment of a support member supporting a heated object in container 150. In a case that a heated object can be stirred without protruding piece 152 such as a case that a rotation speed of container 150 is high or in a case that stirring of a heated object and attachment of a support member are not required, it is not necessary to provide protruding piece 152. Protruding piece 152 may removably be attached to container 150.

As shown in FIGS. 6 and 7, a coupling portion 151 coupled to a driveshaft of a motor 170 which will be described later is provided in a bottom portion of container 150. Container 150 and coupling portion 151 may integrally be formed or may be formed separately and joined to each other.

The hot air blowing mechanism is provided in the housing. The hot air blowing mechanism includes an air passage for circulating hot air, a fan 181 provided in the air passage, a fan motor 180 driving the fan, a heater 190 heating air in the air passage, and a flow director 160 determining a direction of blown hot air.

As shown in FIG. 7, in the housing, an intake duct 161 and a heating duct 162 connected to intake duct 161 which form air passages are arranged outside heating chamber 140. Intake duct 161 is disposed around an outer periphery of heating chamber 140. One end side of intake duct 161 is connected to a return port 165 opening into heating chamber 140. The other end side of intake duct 161 is connected to one end side of heating duct 162. Intake duct 161 has an intake port 163 in a part thereof. This intake port 163 is an opening for taking in a small amount of dry outside air into heating chamber 140 for drying a heated object (food).

Fan 181 is provided on one end side in heating duct 162. Heater 190 is provided in the center in heating duct 162. Heating duct 162 has a hot air blow port 164 at the other end.

As shown in FIGS. 7 and 8, hot air blow port 164 is located in the center of an upper end portion of the inner wall of heating chamber 140. Flow director 160 is fixed to an inner surface of door 120 so as to cover an upper portion and a side portion of hot air blow port 164. A tip end of flow director 160 is bent so as to be directed to a lower portion of the bottom portion of inclined container 150.

Return port 165 and an emission port 166 are provided, with hot air blow port 164 lying therebetween, in the upper portion of the inner wall of heating chamber 140. Emission port 166 is connected to exhaust port 113 of main body portion 110 of the housing.

Return port 165 is connected to the other end of intake duct 161. Namely, return port 165 and hot air blow port 164 communicate with each other through intake duct 161 and heating duct 162 on the outside of heating chamber 140. An air passage through which hot air can circulate is thus formed in the housing.

In the present embodiment, output from fan 181 and output from heater 190 can both be varied. Therefore, the hot air blowing mechanism can vary a temperature of blown hot air and a flow rate of hot air. The hot air blowing mechanism is not limited thereto, and it should only be able to vary at least a temperature of hot air. A temperature of blown hot air is, for example, not lower than 40° C. and not higher than 230° C.

The drive mechanism is provided in the housing. The drive mechanism includes motor 170, a cam 171 engaged with the driveshaft of motor 170, and a sensing switch 172 coupled to cam 171 and sensing a position of rotation of container 150. As motor 170 is driven and the driveshaft rotates, container 150 rotationally moves around the central axis of container 150 with coupling portion 151 coupled to this driveshaft being interposed. Sensing switch 172 senses a position of rotation of container 150 based on a position of cam 171 operating in coordination with the driveshaft of motor 170.

In the present embodiment, motor 170 can vary all of a direction of rotation, a rotation speed, and the number of rotations. Therefore, the drive mechanism can rotationally move container 150 with all of a direction of rotation, a rotation speed, and an angle of rotation being varied.

Specifically, the drive mechanism is electrically connected to a not-shown control unit connected to sensing switch 172 and controlling drive of motor 170. The drive mechanism is not limited thereto, and it should only be able to rotationally move the container with at least one of a direction of rotation, a rotation speed, and an angle of rotation being varied. A rotation speed of container 150 is, for example, not lower than 2 rpm and not higher than 20 rpm.

In the present embodiment, heating cooker 100 further includes in the housing, a heating mechanism heating container 150 in proximity to the bottom portion of container 150. Specifically, in heating chamber 140, a heater 191 serving as a heating mechanism is arranged at a prescribed distance from the bottom portion of container 150. Heater 191 heats the bottom portion of container 150 with radiant heat. The structure of the heating mechanism is not limited thereto, and it should only be able to heat container 150 in proximity to at least a part of a peripheral side portion and the bottom portion of container 150. It is not necessarily required to provide a heating mechanism.

An operation of heating cooker 100 will be described below.

Initially, in deep frying, a heated object to which surface cooking oil has been applied or blown in advance as necessary is arranged in container 150, and in drying cooking, a heated object containing moisture is arranged as it is in container 150.

Door 120 is opened and container 150 which has accommodated the heated object is arranged in heating chamber 140. Here, coupling portion 151 and the driveshaft of motor 170 are coupled to each other.

Then, the drive mechanism is driven. Specifically, motor 170 is driven and container 150 is rotationally moved around the central axis of container 150 as shown with an arrow 3 in FIG. 8.

Thereafter, the hot air blowing mechanism is operated. Specifically, fan motor 180 is driven to thereby operate fan 181. As fan 181 operates, blowing of air from one end side to the other end side is started in heating duct 162.

As blowing of air is started, air in the space outside heating chamber 140 in main body portion 110 of the housing is suctioned through intake port 163 of intake duct 161. Air suctioned into intake duct 161 passes through heating duct 162. Here, air which has passed heater 190 is heated to reach a high temperature. Air which has reached a high temperature is blown as hot air through hot air blow port 164 along flow director 160, as shown with an arrow 1 in FIGS. 7 and 8.

Hot air blown into container 150 through hot air blow port 164 mainly reaches the lower portion of the bottom portion of inclined container 150. The hot air blowing mechanism thus blows hot air into container 150 through the opening in container 150.

Hot air blown into container 150 heats the heated object as being in contact with the heated object. The heated object to which surface seasoning oil has been applied or blown is deep fried by being heated with hot air. The heated object containing moisture is dry cooked as moisture in the heated object evaporates by being heated with hot air. Unlike general deep frying in which a heated object is heated in oil, deep frying in the present embodiment refers to cooking by heating, with a small amount of oil adhering to a surface of a heated object.

Hot air which has heated the heated object flows along the inner wall of container 150 and flows out of heating chamber 140 through return port 165 and emission port 166.

Hot air which has flowed out of heating chamber 140 contains moisture which has evaporated from the heated object during heating of the heated object. Some of air at a high humidity containing a large amount of moisture is sent from emission port 166 to exhaust port 113 of the housing and emitted to the outside of heating cooker 100.

Air which has flowed out of return port 165 passes through intake duct 161, it is mixed with outside air taken in through outside air intake port 112 and suctioned through intake port 163, and thereafter it is heated again in heating duct 162. Thus, the hot air blowing mechanism blows hot air into container 150 by circulating air in the housing with some air being replaced.

By maintaining a humidity of hot air blown to a heated object within a prescribed range by exhausting air at a high humidity, oil smoke, and odor, savor of the heated object is not impaired in deep frying of the heated object and the heated object can be dried in a stable manner in dry cooking of the heated object. Furthermore, a degree of contamination in heating chamber 140 can be lowered.

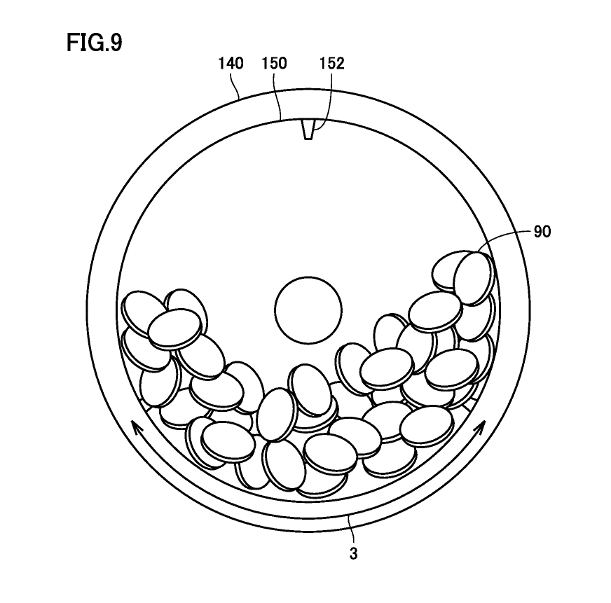

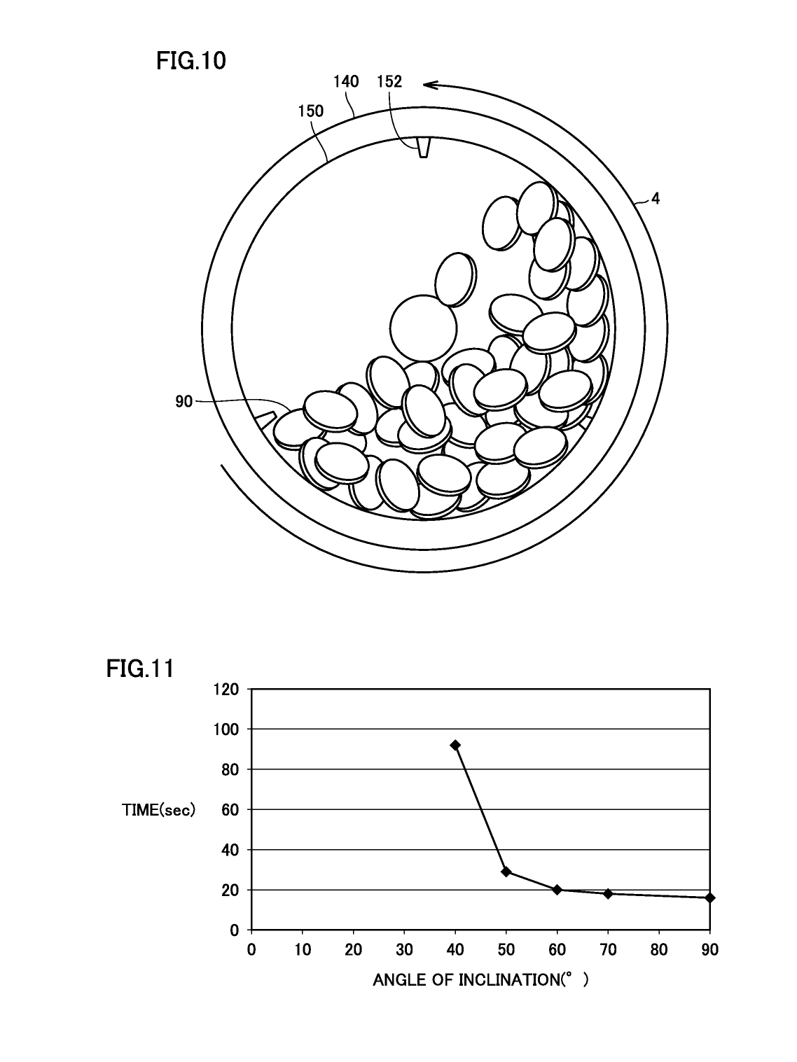

FIG. 9 is a diagram showing a state of the heating cooker according to the present embodiment that a heated object is heated while the container is swung. FIG. 10 is a diagram showing a state of the heating cooker according to the present embodiment that a heated object is heated while the container is rotated in one direction.

Heating cooker 100 according to the present embodiment can heat a heated object 90 in container 150 while container 150 is swung as shown with an arrow 3 in FIG. 9. Specifically, hot air is blown into container 150 while container 150 is rotated in a forward direction and a reverse direction within a range not greater than 90° in any of left and right directions. In such a case, heated object 90 can be stirred little by little.

Heating cooker 100 according to the present embodiment can heat heated object 90 in container 150 while container 150 is rotated in any one direction as shown with an arrow 4 in FIG. 10. Specifically, hot air is blown into container 150 while container 150 is rotated either counterclockwise or clockwise.

By doing so, heated object 90 can vigorously be stirred as if it were thrown into air. Specifically, heated object 90 can effectively be stirred in such a manner that heated object 90 is lifted upward along the inner wall with centrifugal force and thereafter allowed to fall owing to gravity.

As above, in heating cooker 100 according to the present embodiment, the central axis of container 150 is inclined by approximately 45° with respect to the vertical direction. By swinging or rotating container 150 thus inclined, heated object 90 in container 150 can be stirred.

A verification example in which relation between an angle of inclination of the container and a state of stirring of a heated object was verified will be described below. FIG. 11 is a graph showing results in the verification example.

In the verification example, a cylindrical container having an inner diameter of 250 mm and a height of 100 mm was employed. No protruding piece was provided on the inner wall of the cylindrical container. The bottom portion of the cylindrical container was paved with a large number of white foamed polystyrene pieces substantially without a space. Two white foamed polystyrene pieces which had been arranged were taken away to thereby form small spaces. Thereafter, a large number of brown foamed polystyrene pieces were placed over the white foamed polystyrene pieces.

A time period was counted until the white foamed polystyrene pieces and the brown foamed polystyrene pieces were uniformly mixed when the cylindrical container was rotated, with an angle of inclination of the cylindrical container in which a large number of white foamed polystyrene pieces and a large number of brown foamed polystyrene pieces had thus been arranged being varied and a rotation speed being set to 10 rpm.

As shown in FIG. 11, with the central axis of the cylindrical container being inclined by 40° with respect to the vertical direction, it took 92 seconds for the foamed polystyrene pieces to uniformly be mixed. With the central axis of the cylindrical container being inclined by 50° with respect to the vertical direction, it took 29 seconds for the foamed polystyrene pieces to uniformly be mixed. With the central axis of the cylindrical container being inclined by 60° with respect to the vertical direction, it took 20 seconds for the foamed polystyrene pieces to uniformly be mixed. With the central axis of the cylindrical container being inclined by 70° with respect to the vertical direction, it took 18 seconds for the foamed polystyrene pieces to uniformly be mixed. With the central axis of the cylindrical container being inclined by 90° with respect to the vertical direction, it took 16 seconds for the foamed polystyrene pieces to uniformly be mixed.

With the central axis of the cylindrical container being inclined by 30° with respect to the vertical direction, the foamed polystyrene pieces could not uniformly be mixed. Based on such results, it was found that heated object 90 could not effectively be stirred when the angle of inclination of container 150 was excessively small.

When the angle of inclination of container 150 is excessively large, efficiency in stirring improves, whereas an amount of heated object 90 which can be accommodated in container 150 becomes small, which results in lowering in efficiency in heating. When an angle of inclination of container 150 is excessively large in cooking of foodstuffs not requiring strong stirring such as croquettes, the foodstuffs violently move within container 150 and tend to deform. Therefore, the angle of inclination of container 150 is preferably not smaller than 45° and not larger than 60° from an aspect of efficiency in stirring, efficiency in heating, and suppression of deformation of foodstuffs.

As described above, in heating cooker 100 according to the present embodiment, the drive mechanism can rotationally move container 150 with all of a direction of rotation, a rotation speed, and an angle of rotation being varied.

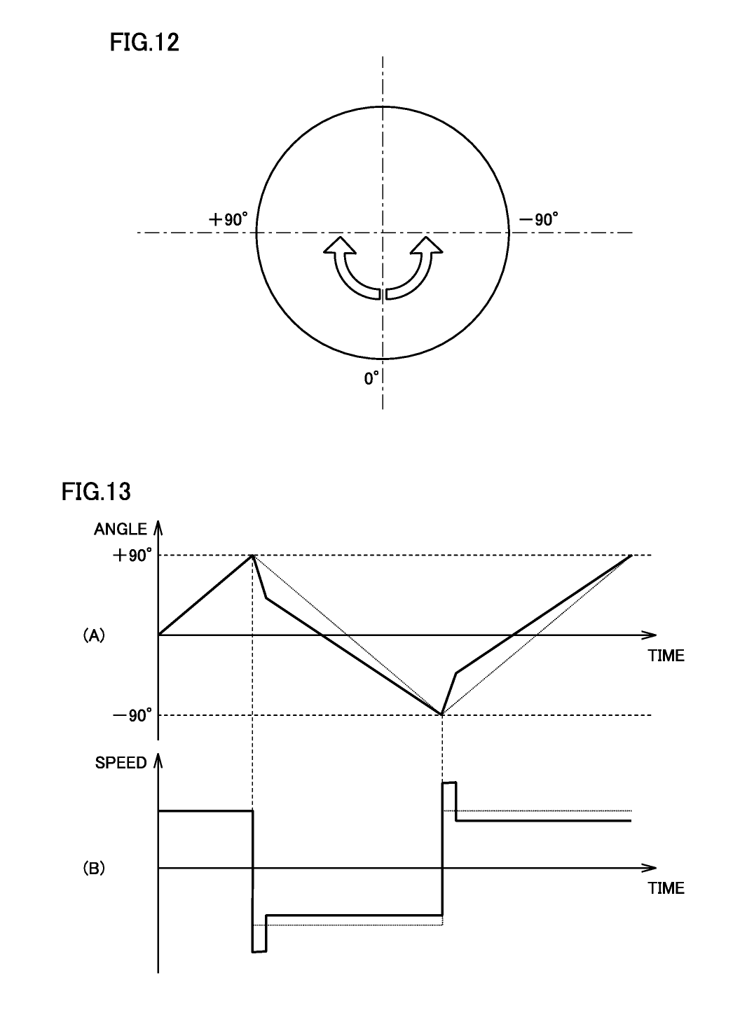

An operation example of the container owing to the drive mechanism will be described below. FIG. 12 is a diagram defining a direction of rotation of the container. As shown in FIG. 12, rotation to the left and rotation to the right in connection with a direction of rotation and an angle of rotation are defined as positive and negative, respectively, when container 150 is viewed from the opening. Rotation to the left and rotation to the right in connection with a rotation speed are also defined as positive and negative, respectively.

FIG. 13 is a diagram showing a first operation example of the container owing to the drive mechanism. FIG. 13 (A) shows an angle of rotation of the container on the ordinate and an elapsed time on the abscissa. FIG. 13 (B) shows a rotation speed of the container on the ordinate and an elapsed time on the abscissa. The abscissa in FIG. 13 (A) and the abscissa in FIG. 13 (B) represent the same time axis.

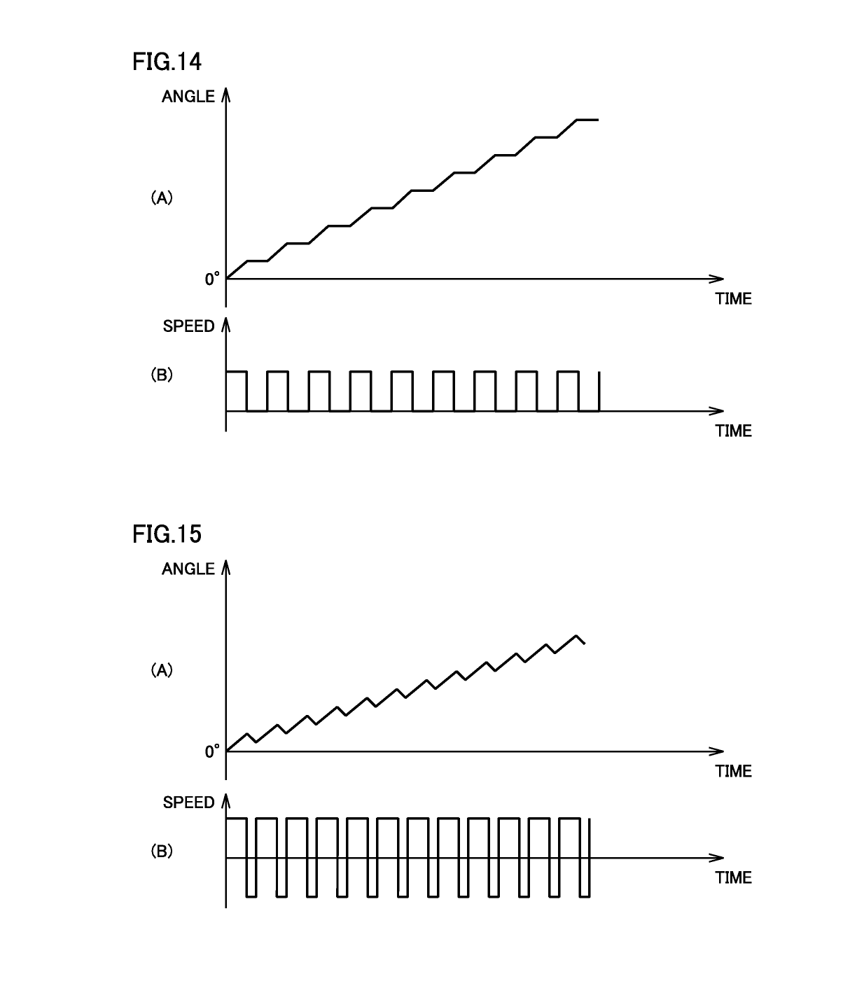

FIG. 14 is a diagram showing a second operation example of the container owing to the drive mechanism. FIG. 14 (A) shows an angle of rotation of the container on the ordinate and an elapsed time on the abscissa. FIG. 14 (B) shows a rotation speed of the container on the ordinate and an elapsed time on the abscissa. The abscissa in FIG. 14 (A) and the abscissa in FIG. 14 (B) represent the same time axis.

FIG. 15 is a diagram showing a third operation example of the container owing to the drive mechanism. FIG. 15 (A) shows an angle of rotation of the container on the ordinate and an elapsed time on the abscissa. FIG. 15 (B) shows a rotation speed of the container on the ordinate and an elapsed time on the abscissa. The abscissa in FIG. 15 (A) and the abscissa in FIG. 15 (B) represent the same time axis.

As shown in FIG. 13, in the first operation example, container 150 is swung in both directions in a range not smaller than −90° and not greater than 90°. Container 150 is swung such that an absolute value for a rotation speed immediately after change in direction of container 150 is greater than an absolute value of a rotation speed immediately before change in direction of container 150.

By thus swinging container 150, inertial force applied to heated object 90 at the time of change in direction of container 150 is increased, so that stirring as flipping heated object 90 can be carried out. This operation is suitable, for example, in stir-frying rice.

As shown in FIG. 14, in the second operation example, container 150 is intermittently rotated such that a period during which container 150 is rotated at a constant rotation speed to the left and a prescribed stop period are repeated. Therefore, container 150 is rotated to the left as the time elapses.

By thus rotating container 150, a heated object located on the bottom portion of container 150 and moving around a circumferential direction of container 150 with rotation of container 150 can uniformly be heated. In this case, the heated object is not stirred. This operation is suitable, for example, in deep frying of croquettes which tend to deform.

As shown in FIG. 15, in the third operation example, container 150 is rotationally moved alternately to the left and to the right. In addition, container 150 is rotationally moved such that an angle of rotation to the left of container 150 is greater than an angle of rotation to the right. Therefore, container 150 rotates to the left as the time elapses.

By thus rotationally moving container 150, a direction of rotation of container 150 frequently changes, so that heated object 90 can frequently be stirred. This operation is suitable, for example, in deep frying of potatoes or vegetables.

A method of operating container 150 is not limited to the above. Continuous rotation in one direction alone may be acceptable, container 150 may be stopped without being rotated, or combination thereof may be acceptable.

In heating cooker 100 according to the present embodiment, a support member supporting a heated object is arranged in container 150 in a case that croquettes of which shape tends to deform are deep fried or in a case that dry fruits are prepared by drying banana chips or the like which tend to stick to one another.

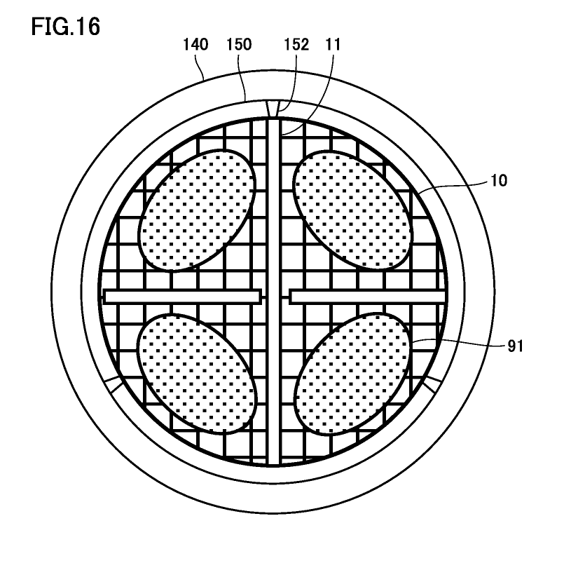

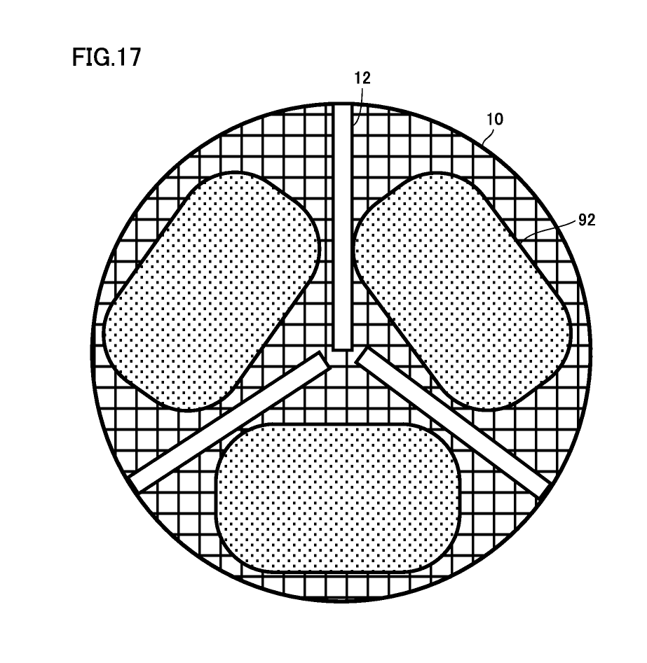

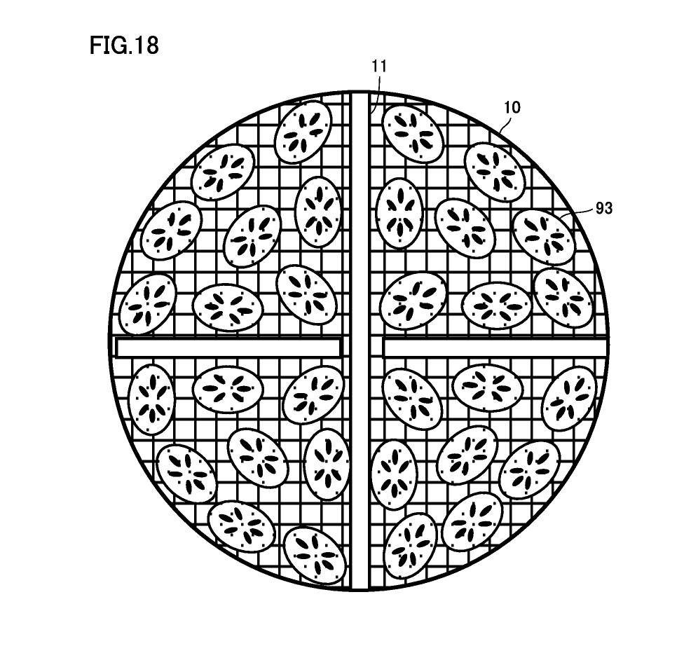

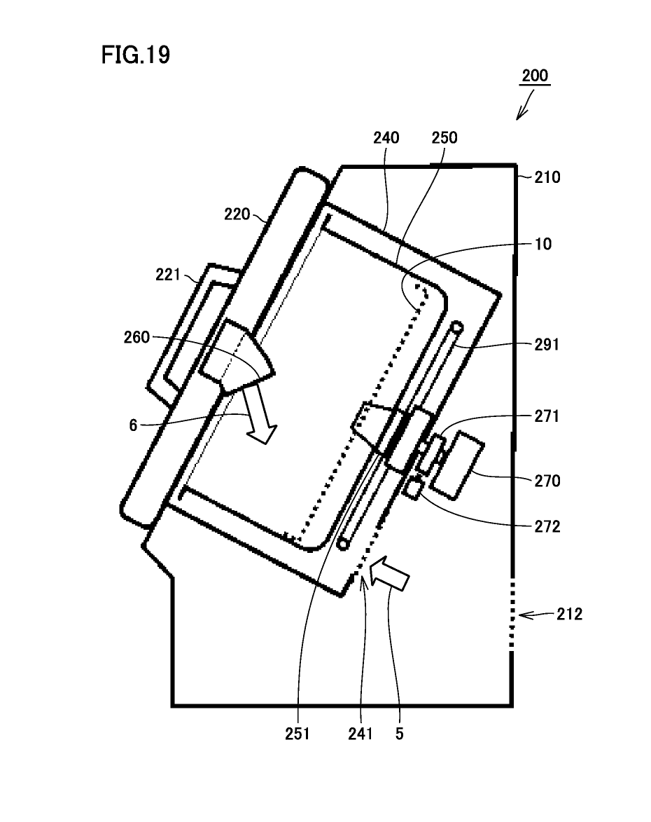

FIG. 16 is a diagram showing a state that four heated objects are evenly placed on a support member arranged in the container. FIG. 17 is a diagram showing a state that three heated objects are evenly placed on the support member. FIG. 18 is a diagram showing a state that a plurality of heated objects which tend to stick with one another are evenly arranged on the support member.

As shown in FIGS. 16 to 18, a support member 10 is arranged in container 150 in a case that a heated object 91 or 92 which tends to deform such as croquettes and in a case that heated objects 93 which tend to stick to one another such as banana chips are dried.

In the present embodiment, support member 10 is made of a metallic mesh. Support member 10 is engaged with protruding piece 152 of container 150. Thus, support member 10 rotationally moves around the central axis of container 150 together with container 150. A prescribed gap is formed between support member 10 and the bottom portion of container 150.

A partition 11 is provided on support member 10. A structure of the partition is various, and in a state shown in FIGS. 16 and 18, support member 10 is partitioned into four by partition 11. In a state shown in FIG. 17, a partition 12 partitions support member 10 into three.

Arrangement of heated objects is also various. As shown in FIGS. 16 and 17, one heated object 91 or 92 may be arranged in each region on support member 10 resulting from partition by partition 11 or 12. Alternatively, as shown in FIG. 18, a plurality of heated objects 93 may be arranged in each region on support member 10 resulting from partition by partition 11.

By thus changing arrangement of a partition and a heated object depending on a size of the heated object or a way of cooking, deformation of heated object 91 or 92 due to movement thereof on support member 10 or sticking of heated objects 93 to one another due to movement thereof when container 150 is rotationally moved can be suppressed.

In deep frying of heated object 91 which tends to deform such as croquettes arranged as shown in FIG. 16, for example, such a state that one heated object 91 is located on the lower portion of the bottom portion of container 150 and directly blown with hot air at a temperature around 200° C. is held (rotation of container 150 is stopped) for one minute and thereafter container 150 is rotated by 90° in one minute.

Then, next heated object 91 is located on the lower portion of the bottom portion of container 150 and it will directly be blown with hot air. This state is held (rotation of container 150 is stopped) for one minute, and thereafter container 150 is rotated by 90° in one minute. By repeating this operation, four heated objects 91 can be heated by being uniformly blown with hot air.

By thus slowly rotating container 150, movement of heated object 91 on support member 10 can be suppressed, and contact of heated object 91 with partition 11 or the inner wall of container 150 which will result in deformation can be prevented.

In drying of heated objects 93 which tend to stick with one another such as banana chips arranged as shown in FIG. 18, container 150 continues to be rotated in one direction at a rotation speed of 1 rpm while hot air at a temperature around 100° C. is blown. With this operation, a plurality of heated objects 93 can be dried by being uniformly blown with hot air.

By thus slowly rotating container 150, movement of heated object 93 on support member 10 can be suppressed, and sticking of heated objects 93 to one another can be prevented.

As above, support member 10 is formed from a metallic mesh and a prescribed gap is formed between support member 10 and the bottom portion of container 150. Therefore, hot air blown into container 150 passes through meshes of support member 10 and reaches the bottom portion of container 150, and thereafter it tumbles and comes in contact with a bottom side of the heated object in container 150. Thus, since the entire surface of the heated object comes in contact with hot air, the entire heated object can uniformly be heated.

Extra oil or moisture which has flowed out of the heated object can drop through the meshes of support member 10 toward the bottom portion of container 150. Thus, calories of the heated object can be lowered, which can contribute to promotion of good health and improvement in texture of the heated object.

Heating cooker 100 can also dry a heated object in dry cooking of the heated object with influence by heating being minimized, by setting a temperature of hot air to a temperature as low as approximately 40° C. and continuing to blow hot air toward the heated object for several hours. Since food can thus be dried at a low temperature at which enzymes contained in the food are not deactivated, dry food can be produced while decrease in enzymes useful for a human body is suppressed.

Alternatively, heating cooker 100 can also achieve heating cooking such as preparation of Chinese dishes for which high-temperature cooking is done, by blowing hot air to a heated object while container 150 itself is set to a high temperature by operating heater 191 arranged below the bottom portion of container 150.

According to heating cooker 100 in the present embodiment, menus other than the above can also be carried out. For example, since hermeticity of the bottom portion of the container is high, such a menu as soup, risotto, or rice cooking high in moisture content can also be handled as cooking by homogenous stirring making use of rotation of the container.

As above, heating cooker 100 according to the present embodiment can uniformly heat a heated object in accordance with characteristics of the heated object. The control unit described above determines an operation of each feature of heating cooker 100 in accordance with a sequence stored in advance, based on a recipe or a cooking method input (selected) by a user of heating cooker 100.

Heating cooker 100 according to the present embodiment can intensively blow hot air while individual foodstuff is highly separated by stirring by rotation of container 150 itself during cooking by strong stirring as in deep frying of potatoes. Therefore, hot air spreads over individual foodstuffs and even heating can be achieved, and hence a time period for heating cooking can be shortened by enhancing efficiency in heat transfer.

In cooking not requiring strong stirring as in cooking of croquettes, local heat transfer is improved by intensively blowing hot air to food, so that fries can be deliciously brown and crisp, and even frying can be achieved by rotation of the container.

Furthermore, a cooking method free from immersion of food in a large amount of oil as in a conventional example is performed. Therefore, absorption of oil into foodstuffs can be suppressed, extra oil of the foodstuffs can be cut, and healthy cooking can be achieved. In addition, since no waste oil is produced, environmentally friendly cooking can be achieved.

A heating cooker according to a second embodiment of the present invention will be described below with reference to the drawings. Since a heating cooker 200 according to the present embodiment is different from heating cooker 100 according to the first embodiment only in that a hot air blow port 260 is provided in the door, description of other features will not be repeated.

### Second Embodiment

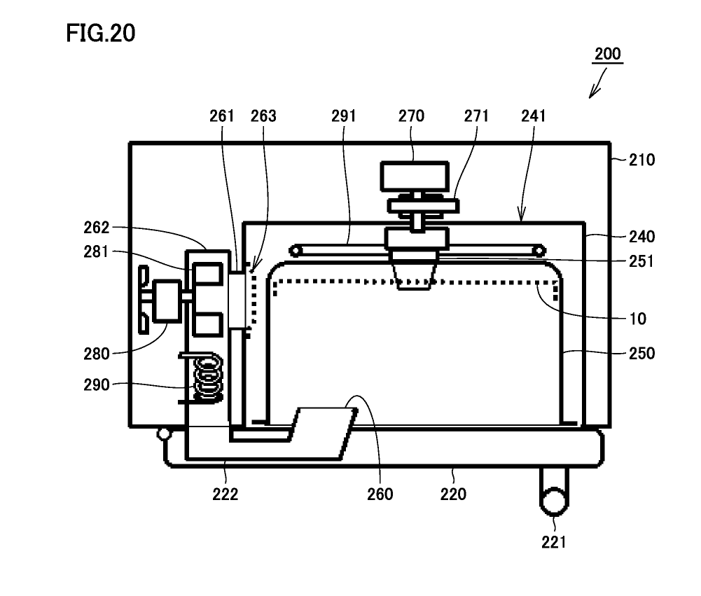

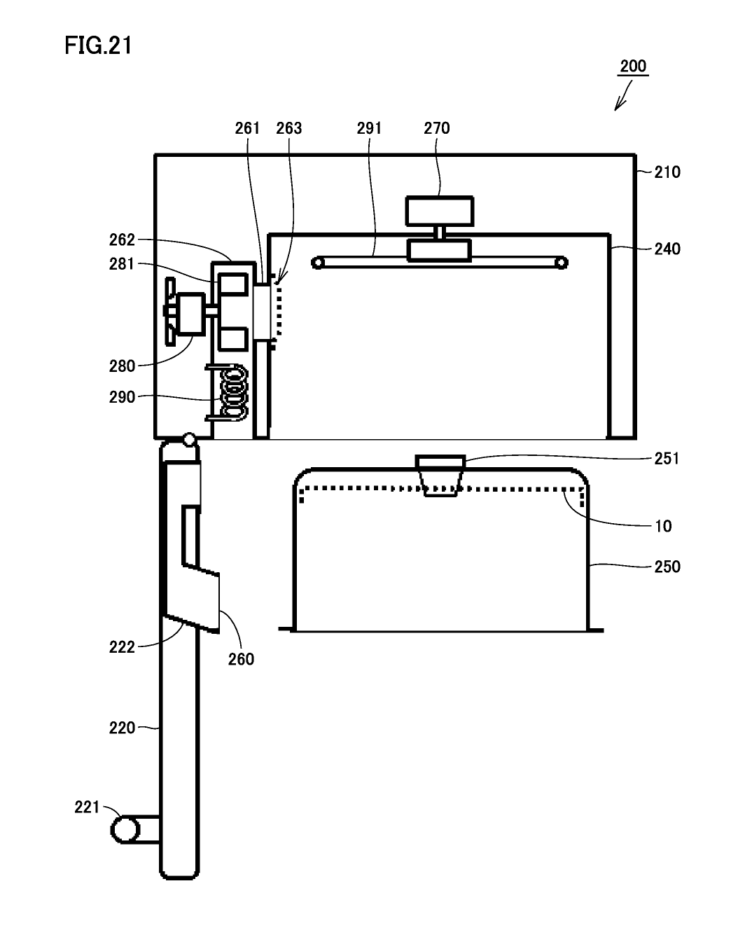

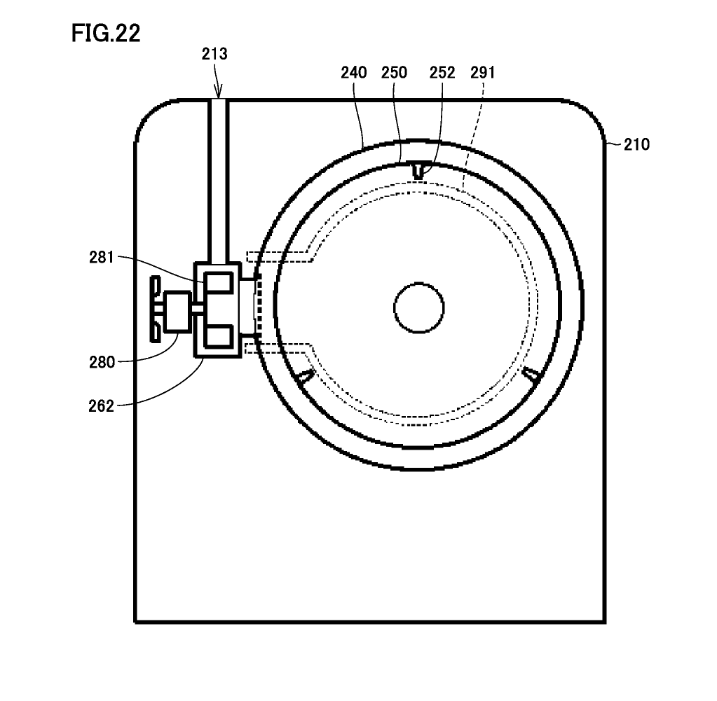

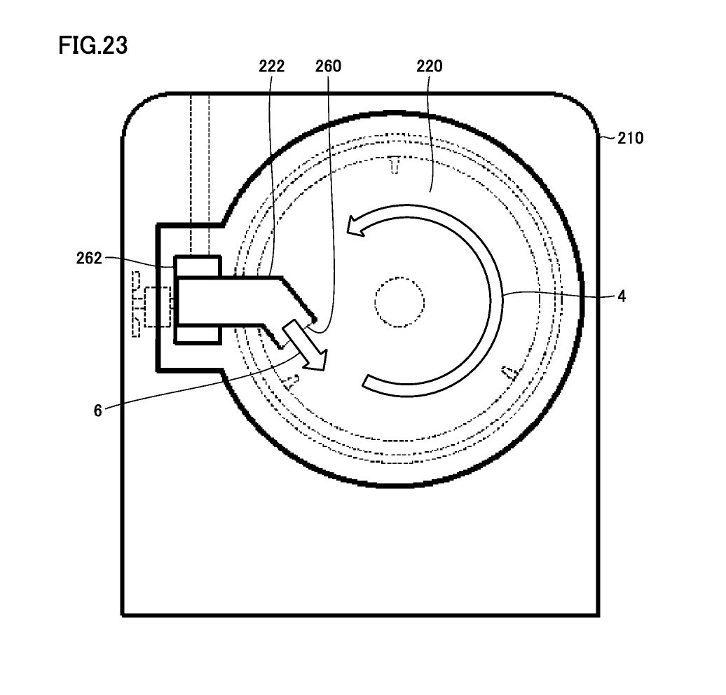

FIG. 19 is a vertical cross-sectional view showing a structure of a heating cooker according to the second embodiment of the present invention. FIG. 20 is a lateral cross-sectional view showing a structure of the heating cooker according to the present embodiment. FIG. 21 is a lateral cross-sectional view showing a state of the heating cooker according to the present embodiment that a container has been removed by opening the door. FIG. 22 is a vertical cross-sectional view across a main body portion of a housing in the heating cooker according to the present embodiment. FIG. 23 is a vertical cross-sectional view across the door of the heating cooker according to the present embodiment.

As shown in FIGS. 19 to 21, heating cooker 200 according to the second embodiment of the present invention includes a housing, a container 250 accommodated in the housing with a central axis being inclined at a prescribed angle with respect to the vertical direction, for accommodating a heated object, a hot air blowing mechanism blowing hot air into container 250, and a drive mechanism rotationally moving container 250 around the central axis.

As shown in FIGS. 19 to 23, the housing includes a main body portion 210 substantially in a parallelepiped shape and a door 220 coupled to main body portion 210. Door 220 is provided obliquely above main body portion 210. A handle 221 is provided at a right end of door 220.

An outside air intake port 212 including a plurality of holes is formed in a lower portion of a side of main body portion 210 of the housing. As shown in FIG. 22, an exhaust port 213 is formed in an upper portion of main body portion 210 of the housing. Exhaust port 213 is connected to an upper portion of a heating duct 262.

As shown in FIGS. 19 to 21, a heating chamber 240 is provided in main body portion 210 of the housing. Heating chamber 240 has an opening opened and closed by door 220. An intake port 241 is formed in a bottom portion of heating chamber 240.

A space is formed outside heating chamber 240 within main body portion 210 of the housing. This space is in contact with outside air intake port 212 and intake port 241.

Container 250 is arranged in heating chamber 240. Container 250 has an opening at an upper end. Container 250 arranged in heating chamber 240 has a central axis inclined at a prescribed angle with respect to the vertical direction. In the present embodiment, the central axis of container 250 is inclined by approximately 45° with respect to the vertical direction. The prescribed angle is not limited thereto, and the angle may be, for example, not smaller than 45° and not greater than 60°. Specifically, a central axis of heating chamber 240 is inclined at a prescribed angle with respect to the vertical direction. Container 250 is rotationally movably supported by a plurality of not-shown rollers provided between a peripheral wall of container 250 and an inner wall of heating chamber 240. Consequently, the central axis of container 250 is inclined at a prescribed angle with respect to the vertical direction. The opening in container 250 arranged in heating chamber 240 is opposed to door 220 at a prescribed distance therefrom.

As shown in FIG. 22, a protruding piece 252 in a flat plate shape which protrudes inward of container 250 is provided on an inner wall of container 250. In the present embodiment, three protruding pieces 252 are provided evenly at an interval of 120° on the inner wall of container 250.

This protruding piece 252 functions as a stirring plate in stirring of a heated object and an attachment plate in attachment of a support member supporting a heated object in container 250. In a case that a heated object can be stirred without protruding piece 252 such as a case that a rotation speed of container 250 is high or in a case that stirring of a heated object and attachment of a support member are not required, it is not necessary to provide protruding piece 252. Protruding piece 252 may removably be attached to container 250.

As shown in FIGS. 19 to 21, a coupling portion 251 coupled to a driveshaft of a motor 270 which will be described later is provided on a bottom portion of container 250. Container 250 and coupling portion 251 may integrally be formed or may be formed separately and joined to each other.

The hot air blowing mechanism is provided in the housing. The hot air blowing mechanism includes an air passage for circulating hot air, a fan 281 provided in the air passage, a fan motor 280 driving the fan, a heater 290 heating air in the air passage, and a hot air blow port 260 determining a direction of blown hot air.

As shown in FIGS. 20 and 21, an intake duct 261, heating duct 262 connected to intake duct 261, and an in-door duct 222 connected to heating duct 262 and located within door 220, which form air passages in the housing, are arranged.

Intake duct 261 has an intake port 263 at one end, which is located in the inner wall of heating chamber 240. The other end side of intake duct 261 is connected to the one end side of heating duct 262.

Fan 281 is provided on one end side in heating duct 262. Heater 290 is provided on the other end side in heating duct 262. Heating duct 262 has the other end side removably connected to one end side of in-door duct 222.

The other end of in-door duct 222 is connected to hot air blow port 260. Hot air blow port 260 protrudes from door 220 and is located within the opening in container 250 while door 220 is closed. As shown in FIGS. 19, 20, and 23, a tip end of hot air blow port 260 is bent so as to be directed to a lower portion of the bottom portion of inclined container 250.

As shown in FIGS. 19 and 20, since there is a prescribed gap between door 220 and the opening in container 250 while door 220 is closed, a space lying between the inner wall of heating chamber 240 and container 250 communicates with the inside of container 250.

A space lying between the inner wall of heating chamber 240 and container 250 is in contact with intake port 263. Namely, hot air blow port 260 and intake port 263 communicate with each other through the inside of container 250 and the space lying between the inner wall of heating chamber 240 and container 250. An air passage through which hot air can circulate is thus formed in the housing.

In the present embodiment, output from fan 281 and output from heater 290 can both be varied. Therefore, the hot air blowing mechanism can vary a temperature of blown hot air and a flow rate of hot air. The hot air blowing mechanism is not limited thereto, and it should only be able to vary at least a temperature of hot air. A temperature of blown hot air is, for example, not lower than 40° C. and not higher than 230° C.

The drive mechanism is provided in the housing. The drive mechanism includes motor 270, a cam 271 engaged with the driveshaft of motor 270, and a sensing switch 272 coupled to cam 271 and sensing a position of rotation of container 250.

As motor 270 is driven and the driveshaft rotates, container 250 rotationally moves around the central axis of container 250 with coupling portion 251 coupled to this driveshaft being interposed. Sensing switch 272 senses a position of rotation of container 250 based on a position of cam 271 operating in coordination with the driveshaft of motor 270.

In the present embodiment, motor 270 can vary all of a direction of rotation, a rotation speed, and the number of rotations. Therefore, the drive mechanism can rotationally move container 250 with all of a direction of rotation, a rotation speed, and an angle of rotation being varied.

Specifically, the drive mechanism is electrically connected to a not-shown control unit connected to sensing switch 272 and controlling drive of motor 270. The drive mechanism is not limited thereto, and it should only be able to rotationally move the container with at least one of a direction of rotation, a rotation speed, and an angle of rotation being varied. A rotation speed of container 250 is, for example, not lower than 2 rpm and not higher than 20 rpm.

In the present embodiment, heating cooker 200 further includes in the housing, a heating mechanism heating container 250 in proximity to the bottom portion of container 250. Specifically, in heating chamber 240, a heater 291 serving as a heating mechanism is arranged at a prescribed distance from the bottom portion of container 250. Heater 291 heats the bottom portion of container 250 with radiant heat. The structure of the heating mechanism is not limited thereto, and it should only be able to heat container 250 in proximity to at least a part of a peripheral side portion and the bottom portion of container 250. It is not necessarily required to provide a heating mechanism.

An operation of heating cooker 200 will be described below.

Initially, in deep frying, a heated object to which surface cooking oil has been applied or blown in advance is arranged in container 250, and in drying cooking, a heated object containing moisture is arranged as it is in container 250.

As shown in FIG. 21, door 220 is opened and container 250 which has accommodated the heated object is arranged in heating chamber 240. Here, coupling portion 251 and the driveshaft of motor 270 are coupled to each other.

Then, the drive mechanism is driven. Specifically, motor 270 is driven and container 250 is rotationally moved around the central axis of container 250 as shown with an arrow 4 in FIG. 23.

Thereafter, the hot air blowing mechanism is operated. Specifically, fan motor 280 is driven to thereby operate fan 281. As fan 281 operates, blowing of air from one end side to the other end side is started in heating duct 262.

As blowing of air is started, air in the space lying between the inner wall of heating chamber 240 and container 250 is suctioned through intake port 263 of intake duct 261. Air suctioned into intake duct 261 passes through heating duct 262. Here, air which has passed heater 290 is heated to reach a high temperature. Air which has reached a high temperature passes through in-door duct 222 and blown as hot air through hot air blow port 260, as shown with an arrow 6 in FIGS. 19 and 23.

Hot air blown into container 250 through hot air blow port 260 mainly reaches the lower portion of the bottom portion of inclined container 250. In the present embodiment, hot air is blown in a tangential direction of the peripheral wall of container 250 as shown in FIG. 23. The hot air blowing mechanism thus blows hot air into container 250 through the opening in container 250.

Hot air blown into container 250 heats the heated object as being in contact with the heated object. In the present embodiment, hot air is blown in the tangential direction of the peripheral wall of container 250 as above. Therefore, a swirl in a circumferential direction can be generated in container 250. This swirl of hot air can allow uniform heating of a heated object in container 250 as a whole.

Hot air which has heated the heated object flows along the inner wall of container 250 and flows out into the space lying between the inner wall of heating chamber 240 and container 250 through a prescribed gap between door 220 and the opening in container 250.

Hot air which has flowed out into the space lying between the inner wall of heating chamber 240 and container 250 contains moisture which has evaporated from the heated object during heating of the heated object. This air at a high humidity containing a large amount of moisture is mixed with outside air suctioned through outside air intake port 212 and intake port 241 as shown with an arrow 5 and thereafter taken in through intake port 263, and again flows into heating duct 262.

Some of air which has flowed into heating duct 262 is sent to exhaust port 213 and emitted out of heating cooker 100. In particular, since air at a high humidity is located in the upper portion in heating duct 262, mainly air at a high humidity is emitted through exhaust port 213.

The remainder of air which has flowed into heating duct 262 is heated by heater 290. Thus, the hot air blowing mechanism blows hot air into container 250 by circulating air in the housing with some air being replaced.

By maintaining a humidity of hot air blown to a heated object within a prescribed range by exhausting air at a high humidity, savor of the heated object is not impaired in deep frying of the heated object and a heated object can be dried in a stable manner in dry cooking of the heated object. Furthermore, a degree of contamination in heating chamber 240 can be lowered.

In heating cooker 200 according to the present embodiment as well, a heated object can uniformly be heated in accordance with characteristics of the heated object.

A heating cooker according to a third embodiment of the present invention will be described below with reference to the drawings. Since a heating cooker 300 according to the present embodiment is different from heating cooker 100 according to the first embodiment only in further including an angle adjustment mechanism capable of adjusting an angle of inclination of the housing, description of other features will not be repeated.

### Third Embodiment

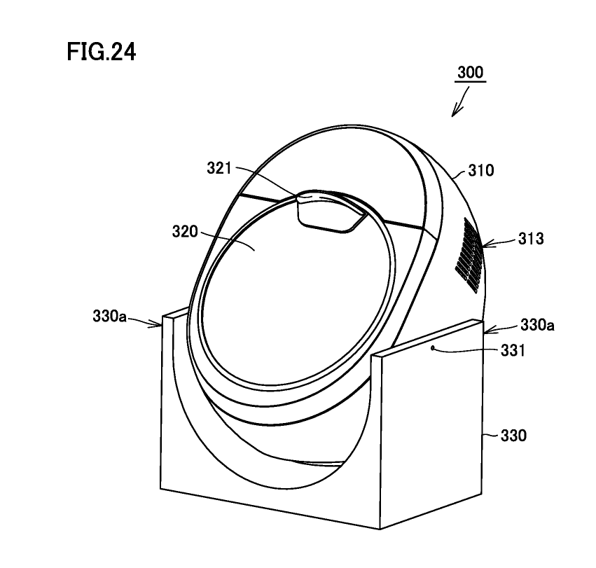

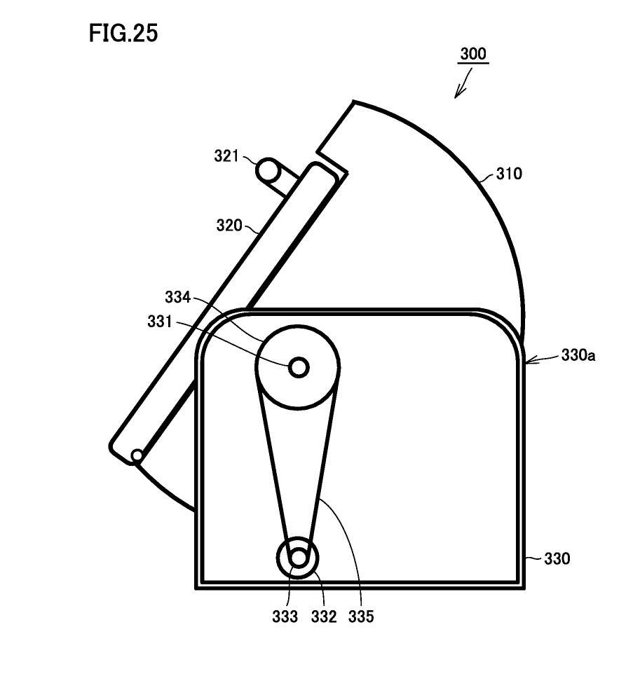

FIG. 24 is a perspective view showing appearance of a heating cooker according to the third embodiment of the present invention. FIG. 25 is a see-through view showing a structure of an angle adjustment mechanism of the heating cooker according to the present embodiment. In FIG. 25, only a base 330 is shown as being seen through.

Heating cooker 300 according to the third embodiment of the present invention includes a housing, a container accommodated in the housing with a central axis being inclined at a prescribed angle with respect to the vertical direction, for accommodating a heated object, a hot air blowing mechanism blowing hot air into the container, and a drive mechanism rotationally moving the container around the central axis.

As shown in FIGS. 24 and 25, the housing includes a substantially hemispherical main body portion 310 and a door 320 coupled to main body portion 310. The housing is supported such that an angle of inclination with respect to base 330 is variable.

Specifically, base 330 has a pair of arm portions 330a opposed to each other such that the housing lies therebetween. A shaft 331 serving as a center of rotational movement of the housing is inserted into each of the pair of arm portions 330a. One end of each shaft 331 is fixed to a side portion of the housing. The other end of each shaft 331 is supported in a rotationally movable manner by a not-shown bearing incorporated in arm portion 330a. According to such a feature, an angle of inclination of the housing can be adjusted by rotationally moving shaft 331.

At a basic position of heating cooker 300 as shown in FIGS. 24 and 25, door 320 is provided obliquely above main body portion 310. A handle 321 is provided at an upper end of door 320. An exhaust port 313 including a plurality of holes is formed in an upper portion of a side of main body portion 310 of the housing.

As shown in FIG. 25, heating cooker 300 includes the angle adjustment mechanism coupled to the housing and inclining the housing so as to vary a prescribed angle. The angle adjustment mechanism includes shaft 331, a motor 332, a belt 335 coupled to a driveshaft 333 of motor 332, and a pulley 334 coupled to shaft 331.

In the angle adjustment mechanism, motor 332 is operated to rotate driveshaft 333, so that pulley 334 can be rotated with belt 335 being interposed to lower a speed. As pulley 334 rotates, shaft 331 rotates. Since one end of shaft 331 is fixed to the side portion of the housing as above, the housing rotates around shaft 331 as shaft 331 rotates.

The angle adjustment mechanism is not limited to the electric means above, and it may be a mechanism capable of mechanically varying an angle stepwise with the use of a latchet mechanism and allowing a user to make manual adjustment to a desired angle in accordance with a menu or an application.

The angle adjustment mechanism is electrically connected to a control unit storing a rotation speed and a time period of operation of motor 332 and controlling drive of motor 332. The control unit can calculate an angle of inclination of the housing based on a rotation speed and a time period of operation of motor 332.

By thus adjusting an angle of inclination of the housing, an angle of inclination of the container accommodated in the housing can be varied. As described in the verification example in the first embodiment, an angle of inclination of the container is relevant to efficiency in stirring and efficiency in heating of a heated object.

Therefore, by varying an angle of inclination of the container in accordance with characteristics of a heated object, efficiency in stirring and efficiency in heating of a heated object can be improved. For example, when relatively strong stirring of a relatively small amount of heated object is desired, an angle of inclination of the container is set to 60° or greater, and when relatively weak stirring of a relatively large amount of heated object is desired, an angle of inclination of the container is set to 45° or smaller.

By thus varying an angle of inclination of the container by adjusting an angle of inclination of the housing, heating cooking more suitable to characteristics of a heated object and a way of cooking can be done. In heating cooker 300 according to the present embodiment as well, a heated object can uniformly be heated in accordance with characteristics of the heated object.

A heating cooker according to a fourth embodiment of the present invention will be described below with reference to the drawings. Since a heating cooker 400 according to the present embodiment is combination of heating cooker 200 according to the second embodiment and heating cooker 300 according to the third embodiment, description of the already described features will not be repeated.

### Fourth Embodiment

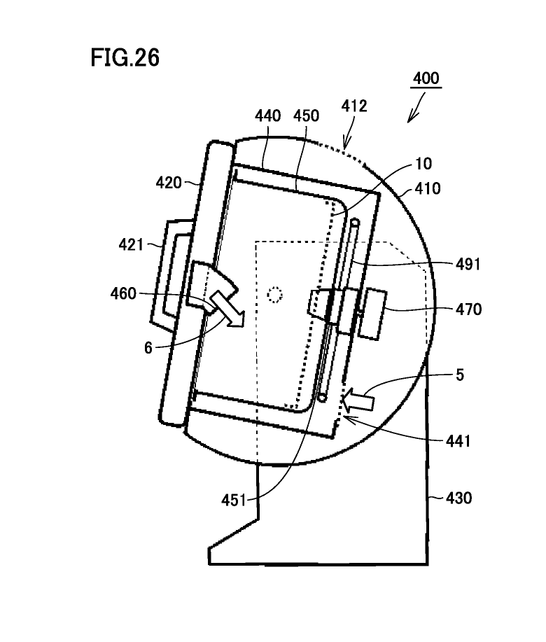

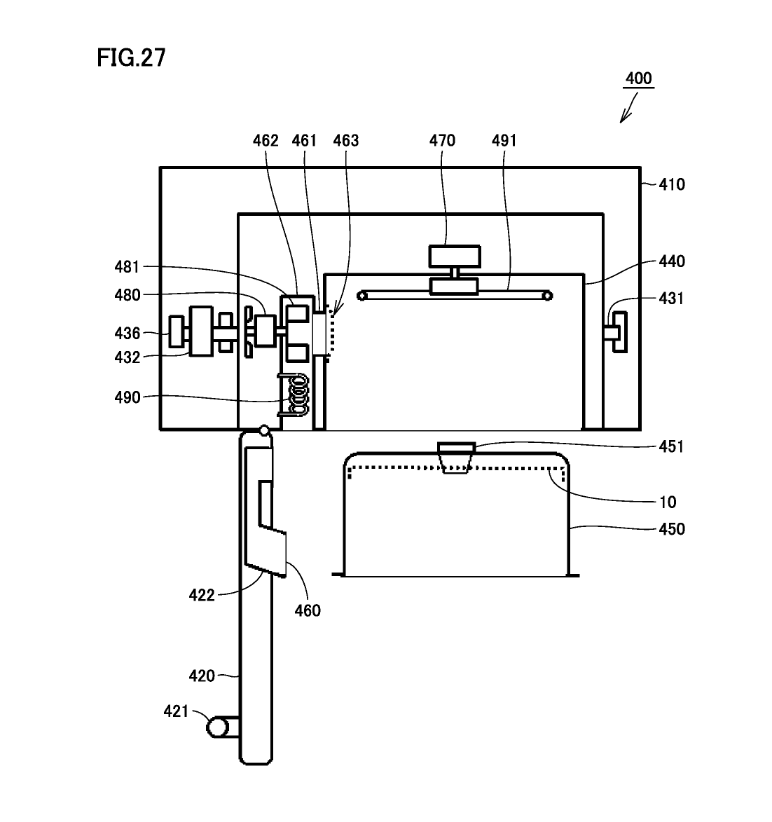

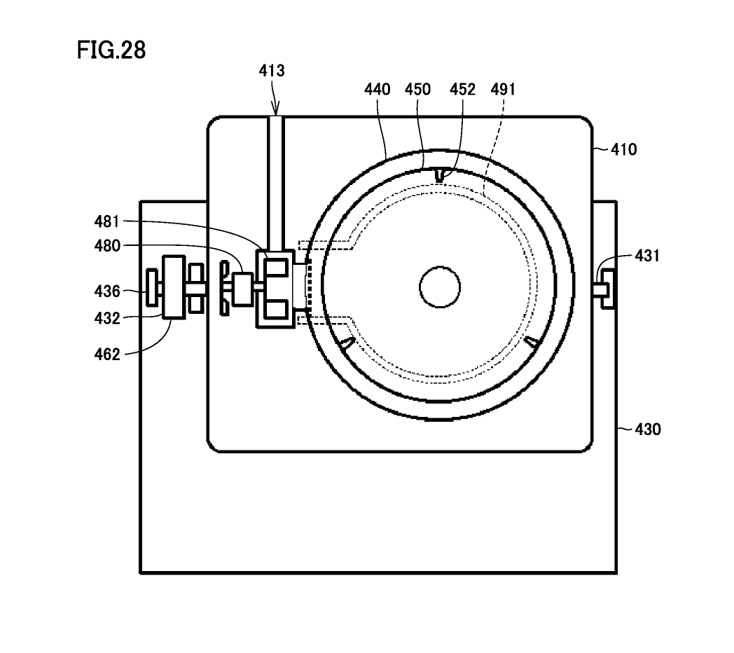

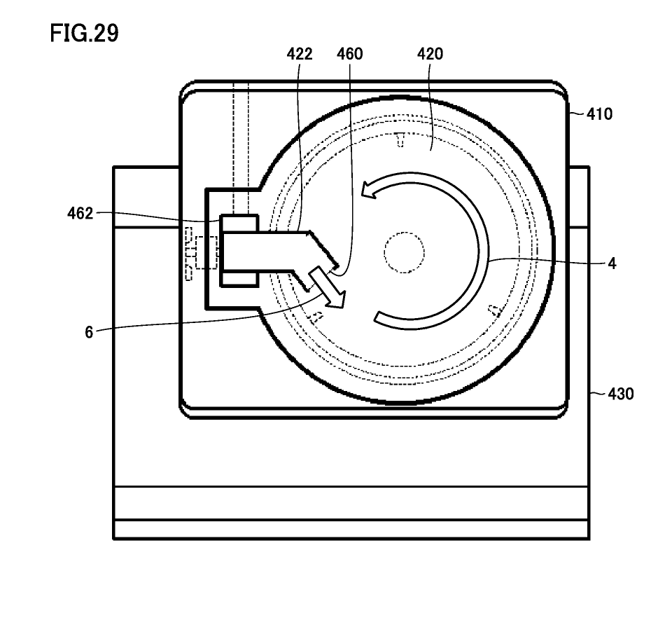

FIG. 26 is a vertical cross-sectional view showing a structure of a heating cooker according to the fourth embodiment of the present invention. FIG. 27 is a lateral cross-sectional view showing a state of the heating cooker according to the present embodiment that a container has been removed by opening a door. FIG. 28 is a vertical cross-sectional view across a main body portion of a housing in the heating cooker according to the present embodiment. FIG. 29 is a vertical cross-sectional view across the door of the heating cooker according to the present embodiment.

As shown in FIGS. 26 to 29, a heating cooker 400 according to the fourth embodiment of the present invention includes a housing, a container 450 accommodated in the housing with a central axis being inclined at a prescribed angle with respect to the vertical direction, for accommodating a heated object, a hot air blowing mechanism blowing hot air into container 450, and a drive mechanism rotationally moving container 450 around the central axis. Heating cooker 400 includes an angle adjustment mechanism coupled to the housing and inclining the housing so as to vary a prescribed angle.

As shown in FIG. 26, the housing includes a main body portion 410 substantially in a parallelepiped shape and a door 420 coupled to main body portion 410. The housing is supported such that an angle of inclination with respect to a base 430 is variable.

At a basic position of heating cooker 400 as shown in FIG. 26, door 420 is provided obliquely above main body portion 410. A handle 421 is provided at a right end of door 420.

An outside air intake port 412 including a plurality of holes is formed in an upper portion of main body portion 410 of the housing. As shown in FIG. 28, an exhaust port 413 is formed in an upper portion of main body portion 410 of the housing. Exhaust port 413 is connected to an upper portion of a heating duct 462.

As shown in FIGS. 26 to 29, a heating chamber 440 is provided in main body portion 410 of the housing. Heating chamber 440 has an opening opened and closed by door 420. An intake port 441 is formed in a bottom portion of heating chamber 440.

A space is formed outside heating chamber 440 within main body portion 410 of the housing. This space is in contact with outside air intake port 412 and intake port 441.

Container 450 is arranged in heating chamber 440. Container 450 has an opening at an upper end. Container 450 arranged in heating chamber 440 has a central axis inclined at a prescribed angle with respect to the vertical direction.

Container 450 is rotationally movably supported by a plurality of not-shown rollers provided between a peripheral wall of container 450 and an inner wall of heating chamber 440. The opening in container 450 arranged in heating chamber 440 is opposed to door 420 at a prescribed distance therefrom.

As shown in FIG. 28, a protruding piece 452 in a flat plate shape which protrudes inward of container 450 is provided on an inner wall of container 450. In the present embodiment, three protruding pieces 452 are provided evenly at an interval of 120° on the inner wall of container 450.

This protruding piece 452 functions as a stirring plate in stirring of a heated object and an attachment plate in attachment of a support member supporting a heated object in container 450. In a case that a heated object can be stirred without protruding piece 452 such as a case that a rotation speed of container 450 is high or in a case that stirring of a heated object and attachment of a support member are not required, it is not necessary to provide protruding piece 452. Protruding piece 452 may removably be attached to container 450.

As shown in FIGS. 26 and 27, a coupling portion 451 coupled to a driveshaft of a motor 470 which will be described later is provided on a bottom portion of container 450. Container 450 and coupling portion 451 may integrally be formed or may be formed separately and joined to each other.

The hot air blowing mechanism is provided in the housing. The hot air blowing mechanism includes an air passage for circulating hot air, a fan 481 provided in the air passage, a fan motor 480 driving the fan, a heater 490 heating air in the air passage, and a hot air blow port 460 determining a direction of blown hot air.

As shown in FIGS. 26 and 27, an intake duct 461, a heating duct 462 connected to intake duct 461, and an in-door duct 422 connected to heating duct 462 and located within door 420, which form air passages in the housing, are arranged.

Intake duct 461 has an intake port 463 at one end, which is located in the inner wall of heating chamber 440. The other end side of intake duct 461 is connected to the one end side of heating duct 462.

Fan 481 is provided on one end side in heating duct 462. Heater 490 is provided on the other end side in heating duct 462. Heating duct 462 has the other end side removably connected to one end side of in-door duct 422.

The other end of in-door duct 422 is connected to hot air blow port 460. Hot air blow port 460 protrudes from door 420 and is located within the opening in container 450 while door 420 is closed. As shown in FIGS. 26 and 29, a tip end of hot air blow port 460 is bent so as to be directed to a lower portion of the bottom portion of inclined container 450.

As shown in FIG. 26, since there is a prescribed gap between door 420 and the opening in container 450 while door 420 is closed, a space lying between the inner wall of heating chamber 440 and container 450 communicates with the inside of container 450.

A space lying between the inner wall of heating chamber 440 and container 450 is in contact with intake port 463. Namely, hot air blow port 460 and intake port 463 communicate with each other through the inside of container 450 and the space lying between the inner wall of heating chamber 440 and container 450. An air passage through which hot air can circulate is thus formed in the housing.

In the present embodiment, output from fan 481 and output from heater 490 can both be varied. Therefore, the hot air blowing mechanism can vary a temperature of blown hot air and a flow rate of hot air. The hot air blowing mechanism is not limited thereto, and it should only be able to vary at least a temperature of hot air. A temperature of blown hot air is, for example, not lower than 40° C. and not higher than 230° C.

The drive mechanism is provided in the housing. The drive mechanism includes motor 470. As motor 470 is driven and the driveshaft rotates, container 450 rotationally moves around the central axis of container 450 with coupling portion 451 coupled to this driveshaft being interposed.

In the present embodiment, motor 470 can vary all of a direction of rotation, a rotation speed, and the number of rotations. Therefore, the drive mechanism can rotationally move container 450 with all of a direction of rotation, a rotation speed, and an angle of rotation being varied. The drive mechanism, however, is not limited thereto, and it should only be able to rotationally move the container with at least one of a direction of rotation, a rotation speed, and an angle of rotation being varied. A rotation speed of container 450 is, for example, not lower than 2 rpm and not higher than 20 rpm.

In the present embodiment, heating cooker 400 further includes in the housing, a heating mechanism heating container 450 in proximity to the bottom portion of container 450. Specifically, in heating chamber 440, a heater 491 serving as a heating mechanism is arranged at a prescribed distance from the bottom portion of container 450. Heater 491 heats the bottom portion of container 450 with radiant heat. The structure of the heating mechanism is not limited thereto, and it should only be able to heat container 450 in proximity to at least a part of a peripheral side portion and the bottom portion of container 450. It is not necessarily required to provide a heating mechanism.

An operation of heating cooker 400 will be described below.

Initially, in deep frying, a heated object to which surface cooking oil has been applied or blown in advance is arranged in container 450, and in drying cooking, a heated object containing moisture is arranged as it is in container 450.

As shown in FIG. 27, door 420 is opened and container 450 which has accommodated the heated object is arranged in heating chamber 440. Here, coupling portion 451 and the driveshaft of motor 470 are coupled to each other.

Then, the drive mechanism is driven. Specifically, motor 470 is driven and container 450 is rotationally moved around the central axis of container 450 as shown with an arrow 4 in FIG. 29.

Thereafter, the hot air blowing mechanism is operated. Specifically, fan motor 480 is driven to thereby operate fan 481. As fan 481 operates, blowing of air from one end side to the other end side is started in heating duct 462.

As blowing of air is started, air in the space lying between the inner wall of heating chamber 440 and container 450 is suctioned through intake port 463 of intake duct 461. Air suctioned into intake duct 461 passes through heating duct 462. Here, air which has passed heater 490 is heated to reach a high temperature. Air which has reached a high temperature passes through in-door duct 422 and blown as hot air through hot air blow port 460 as shown with an arrow 6 in FIGS. 26 and 29.

Hot air blown into container 450 through hot air blow port 460 mainly reaches the lower portion of the bottom portion of inclined container 450. In the present embodiment, hot air is blown in a tangential direction of the peripheral wall of container 450 as shown in FIG. 29. The hot air blowing mechanism thus blows hot air into container 450 through the opening in container 450.

Hot air blown into container 450 heats the heated object as being in contact with the heated object. In the present embodiment, hot air is blown in the tangential direction of the peripheral wall of container 450 as above. Therefore, a swirl in a circumferential direction can be generated in container 450. This swirl of hot air can allow uniform heating of a heated object in container 450 as a whole.

Hot air which has heated the heated object flows along the inner wall of container 450 and flows out into the space lying between the inner wall of heating chamber 440 and container 450 though a prescribed gap between door 420 and the opening in container 450.

Hot air which has flowed out into the space lying between the inner wall of heating chamber 440 and container 450 contains moisture which has evaporated from the heated object during heating of the heated object. This air at a high humidity containing a large amount of moisture is mixed with outside air taken in through outside air intake port 412 and intake port 441 and thereafter suctioned through intake port 463, and again flows into heating duct 462.

Some of air which has flowed into heating duct 462 is sent to exhaust port 413 and emitted out of heating cooker 400. In particular, since air at a high humidity is located in the upper portion in heating duct 462, mainly air at a high humidity is emitted through exhaust port 413.

The remainder of air which has flowed into heating duct 462 is heated by heater 490. Thus, the hot air blowing mechanism blows hot air into container 450 by circulating air in the housing with some air being replaced.

By maintaining a humidity of hot air blown to a heated object within a prescribed range by exhausting air at a high humidity, savor of the heated object is not impaired in deep frying of the heated object and a heated object can be dried in a stable manner in dry cooking of the heated object. Furthermore, a degree of contamination in heating chamber 240 can be lowered.

In heating cooker 400 according to the present embodiment, an angle of inclination of container 450 accommodated in the housing can be varied by adjusting an angle of inclination of the housing with the use of the angle adjustment mechanism.

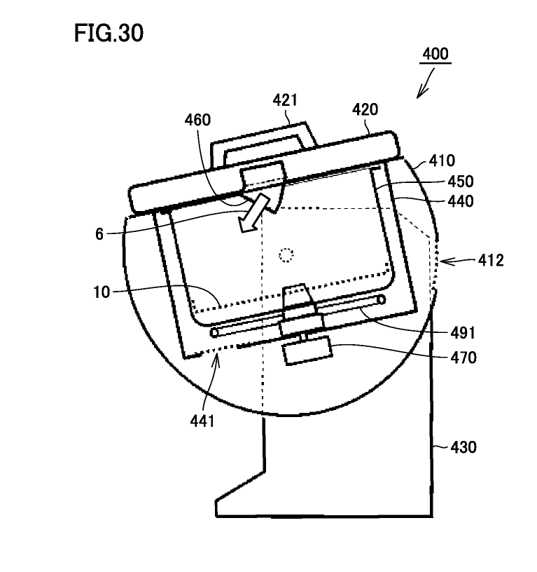

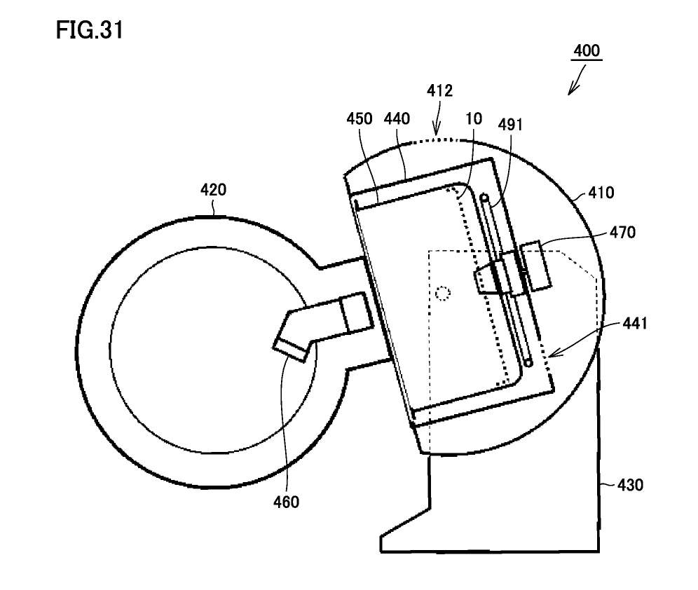

FIG. 30 is a vertical cross-sectional view showing a state that an angle of inclination of a container is set to 5°. FIG. 31 is a vertical cross-sectional view showing a state that the door is opened with an angle of inclination of a container being set to 95°.

As shown in FIG. 30, while an angle of inclination of container 450 is set to 5°, a heated object can easily be placed on support member 10 in a stable manner in accommodating the heated object in container 450 with container 450 being accommodated in heating chamber 440. Alternatively, when seasoning or the like is added to a heated object during heating cooking, an operation can easily be performed by temporarily setting an angle of inclination of container 450 smaller.

With slight inclination by 5°, even while door 420 is open, a user of heating cooker 400 can recognize a position at which hot air is blown through hot air blow port 460 (the lower portion of the bottom portion of container 450).

As shown in FIG. 31, while an angle of inclination of the container is set to 95°, a heated object can easily be transferred to a dish in transfer of the heated object in container 450 thereto. In particular, such setting is suitable when a highly viscous heated object is transferred.

By thus varying an angle of inclination of the container by adjusting an angle of inclination of the housing, heating cooking more suitable to characteristics of a heated object and a way of cooking can be done. In heating cooker 400 according to the present embodiment as well, a heated object can uniformly be heated in accordance with characteristics of the heated object.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

10 support member; 11, 12 partition; 90, 91, 92, 93 heated object; 100, 200, 300, 400 heating cooker; 110, 210, 310, 410 main body portion; 112, 212, 412 outside air intake port; 113, 213, 313, 413 exhaust port; 120, 220, 320, 420 door; 121, 221, 321, 421 handle; 130, 330, 430 base; 140, 240, 440 heating chamber; 150, 250, 450 container; 151, 251, 451 coupling portion; 152, 252, 452 protruding piece; 160 flow director; 161, 261, 461 intake duct; 162, 262, 462 heating duct; 163, 241, 263, 441, 463 intake port; 164, 260, 460 hot air blow port; 165 return port; 166 emission port; 170, 270, 332, 470 motor; 161, 271 cam; 172, 272 sensing switch; 180, 280, 480 fan motor; 181, 281, 481 fan; 190, 191, 290, 291, 490, 491 heater; 222, 422 in-door duct; 330a arm portion; 331 shaft; 333 driveshaft; 334 pulley; and 335 belt.

1. A heating cooker, comprising:
a housing;
a container accommodated in said housing with a central axis being inclined at a prescribed angle with respect to a vertical direction, for accommodating a heated object;
a hot air blowing mechanism blowing hot air into said container; and
a drive mechanism rotationally moving said container around said central axis.

2. The heating cooker according to claim 1, wherein
said housing has a door,
said container has an opening at a position opposed to said door, and
said hot air blowing mechanism blows hot air into said container through said opening.

3. The heating cooker according to claim 1, wherein
said drive mechanism can rotationally move said container with at least one of a direction of rotation, a rotation speed, and an angle of rotation being varied.

4. The heating cooker according to claim 1, wherein
said hot air blowing mechanism can vary a temperature of blown hot air.

5. The heating cooker according to claim 1, further comprising in said housing, a heating mechanism heating said container in proximity to at least a part of a peripheral side portion and a bottom portion of said container.

6. The heating cooker according to claim 1, further comprising an angle adjustment mechanism coupled to said housing, which is capable of adjusting an angle of inclination of said housing so as to vary said prescribed angle.
